(19) United States
(12) Patent Application Publication
(10) Pub. No.: US 2025/0267022 A1
(43) Pub. Date: Aug. 21, 2025

(54) NETWORK DEVICE AND SYSTEM WITH BIDIRECTIONAL ENERGY SUPPLY

(71) Applicant: PHOENIX CONTACT GMBH & CO.KG, Blomberg (DE)

(72) Inventors: Michael GERKE, Watstein (DE); Peter SCHOLZ, Brakel (DE)

(21) Appl. No.: 19/114,964

(22) PCT Filed: Sep. 22, 2023
(86) PCT No.: PCT/EP2023/076227

§ 371 Date: Mar. 25, 2025

(30) Foreign Application Priority Data
Sep. 26, 2022 (DE) 10 2022 124 705.8

(51) Int. Cl. H04L 12/10; H04L 12/40

(52) U.S. Cl. CPC H04L 12/10; H04L 12/40045

(57) ABSTRACT

To improve, simplify and/or make more flexible an energy supply to bus subscribers and/or an energy transmission in a bus system, there is disclosed a network device, which comprises at least one bus interface for connecting the network device to a bus line, in particular a two-wire bus line, wherein the bus interface is designed for data transmission and for energy transmission, and wherein the network device is designed to selectively draw electrical energy from the bus line or to feed electrical energy into the bus line, depending on an operating mode of the network device. Furthermore, a system is disclosed with at least two such network devices, which are connected to each other via a bus line.

### FIELD

Embodiments of the present disclosure relate generally to energy and data transmission in a bus system and in particular to a network device for connection to a bus line, as well as to a system with several such network devices.

### BACKGROUND

Different types of bus systems are used in many areas for data transmission between several subscribers. Depending on the intended use, corresponding bus lines have a different number of wires. Particularly cost-effective and easy-to-handle bus systems make do with a 2-wire line.

In addition to the transmission of data, it is also possible to supply the devices connected to each other via a bus system with electrical energy via the bus system, whereby the bus line can include additional lines for the power supply for this purpose. A power supply via the bus line offers the advantage that a separate power supply for the device, for example with a separate power cable and network device or with a battery, can be dispensed with.

There are also known techniques for using the data lines of a bus system to transmit energy. One such technology is PoDL (Power over Data Line), for example, a modified form of PoE (Power over Ethernet), which is used for example in industrial automation and in the IoT (Internet of Things) sector for simultaneous data and energy transmission with SPE (Single Pair Ethernet). With PoDL, for example, energy is transmitted from a DC voltage source of a bus subscriber to a sink of another bus subscriber. The separation of the additional data transmitted via the two lines, which have comparatively high frequencies, is realized by means of a frequency crossover, also known as diplexing. Inductors and capacitors are generally used, as inductors are highly impedant for the data signal at high frequencies, i.e., they act as a barrier, while capacitors are low-impedance for the high-frequency data signal, i.e., they are permeable. For the low-frequency DC- or AC energy signal for the power supply, inductances are low-impedance, i.e., permeable, whereas capacitances have a blocking effect. In this way, the data signal and energy signal can be transmitted via the same 2 lines.

### SUMMARY

The present disclosure comprises a way of improving, simplifying and/or making more flexible an energy supply of bus subscribers and/or an energy transmission in a bus system.

Embodiments of the present disclosure are shown by features of the independent claims. Other embodiments are shown in the dependent claims, whereby the specified features and advantages can essentially apply to all independent claims.

Embodiments of the present disclosure comprise a network device, which comprises at least one bus interface for connecting the network device to a bus line, in particular to a two-wire bus line, wherein the bus interface is designed for data transmission and for energy transmission, and wherein the network device is designed to selectively draw electrical energy from the bus line or feed electrical energy into the bus line, depending on an operating mode of the network device.

Another embodiment of the present disclosure comprises a network device for connection to a bus line, with which flexible, bidirectional energy transmission is made possible, so, for example, some subscribers can feed energy onto the bus and other subscribers can draw energy from it. In this way, energy can also be advantageously provided for a network device during configuration, so the network device only needs to be connected via the bus interface when put into operation, for example, to configure the network device.

In another embodiment, to separate a combined data and energy signal present at the bus interface into a data signal and an energy signal, or to combine a data and energy signal into a combined data and energy signal, the network device advantageously comprises a diplexing device connected to the bus interface for frequency-selective signal splitting.

Furthermore, another embodiment of the network device comprises a circuit for energy distribution and a transmitting/receiving device for transmitting and receiving data, whereby the bus interface is connected to the circuit for energy distribution and to the transmitting/receiving device via the diplexing device. The diplexing device can be designed in particular to transmit electrical energy between the bus line and the energy distribution circuit and to transmit data signals between the bus line and the transmitting/receiving device, in both directions in each case.

In another embodiment, the network device can have an energy supply device, whereby this can be designed, for example, as a power supply unit for connection to a mains supply or as a battery. Preferably, the network device has a normal operating mode and a configuration operating mode, wherein the network device is supplied with electrical energy by the energy supply device in the normal operating mode and is designed to feed electrical energy provided by the energy supply device into a bus line connected to the bus interface in the normal operating mode, and wherein the network device is designed to draw electrical energy for supplying energy to the network device from a bus line connected to the bus interface in the configuration operating mode. Switching between the normal operating mode and the configuration operating mode preferably takes place automatically depending on whether electrical energy is provided by the energy supply device.

In another embodiment, the network device comprises at least one control unit and one storage unit, wherein the network device is designed to supply at least the control unit and the storage unit with electrical energy in the configuration operating mode and to provide access to the storage unit via the control unit for a further network device, in particular a configuration device, which can be connected to the network device via the bus interface. The control unit and the storage unit can also be formed by a common unit or arranged in a common unit. For example, an integrated circuit (IC) can be provided, which comprises the control unit and the storage unit.

In this way, the network device can be configured in a particularly simple way when starting up by connecting the network device only via the bus interface to a configuration device that supplies the network device with electrical energy via the connection line, so the control unit and the storage of the network device are functional and configuration parameters can be stored in the storage with the help of the configuration device.

In operation, in an embodiment, the configuration operating mode preferably serves as an emergency operating mode, whereby the network device is advantageously designed to automatically switch to the configuration operating mode if the power supply device fails. In this way, the network device can advantageously be supplied with electrical energy via the bus or the bus line if its own energy supply device fails.

To avoid interference, in an embodiment, it may be advantageously provided that the components of the network device involved in data transmission and/or energy transmission via the bus interface are electrically isolated from other components of the network device. The electrical isolation can be realized e.g., inductively, capacitively or optoelectronically.

In another embodiment, the energy distribution circuit is preferably designed to receive, smooth, limit, rectify, switch and/or regulate voltage and/or current signals. In particular, the energy distribution circuit can be designed to provide a supply voltage for the control unit and/or the storage. Trouble-free operation of the control unit and/or the storage is advantageously ensured by voltage regulation and smoothing performed by the energy distribution circuit.

In another embodiment, the network device comprises a measuring device for measuring a voltage applied to the bus line, whereby the network device is designed to feed electrical energy into the bus line only if the polarity of the voltage applied to the bus line is corresponding, or to adjust the polarity of a voltage to be fed into the bus line depending on the voltage measured on the bus line.

In another embodiment, the network device can also have several bus interfaces, for example at least a first and a second bus interface. In such an embodiment, the network device is advantageously designed to selectively establish or interrupt an electrical connection between the first and second bus interfaces.

In another embodiment, the technical problem is further addressed by a system that comprises at least two network devices described above and a bus line, in particular a two-wire bus line, the network devices being connected to one another via the bus line.

In an embodiment, at least one network device of the at least two network devices draws electrical energy from the bus line and at least one other network device of the at least two network devices feeds electrical energy into the bus line. In this way, bus subscribers whose own power supply has failed, for example, can be supplied by other bus subscribers.

### BRIEF DESCRIPTION OF THE DRAWINGS

Further advantages, features and possible applications of the present disclosure will become apparent from the following description of embodiments thereof and shown in the figures. The figures are schematic representations wherein:

FIG. 1 shows a schematic and simplified the structure of a preferred embodiment of a network device according to an embodiment of the present disclosure;

FIG. 2 shows a schematic of how PoDL works in principle;

FIG. 3 shows a schematic and highly simplified embodiment of a system according to the present disclosure; and

FIG. 4 shows a schematic and highly simplified embodiment of a system according to the present disclosure.

### DETAILED DESCRIPTION

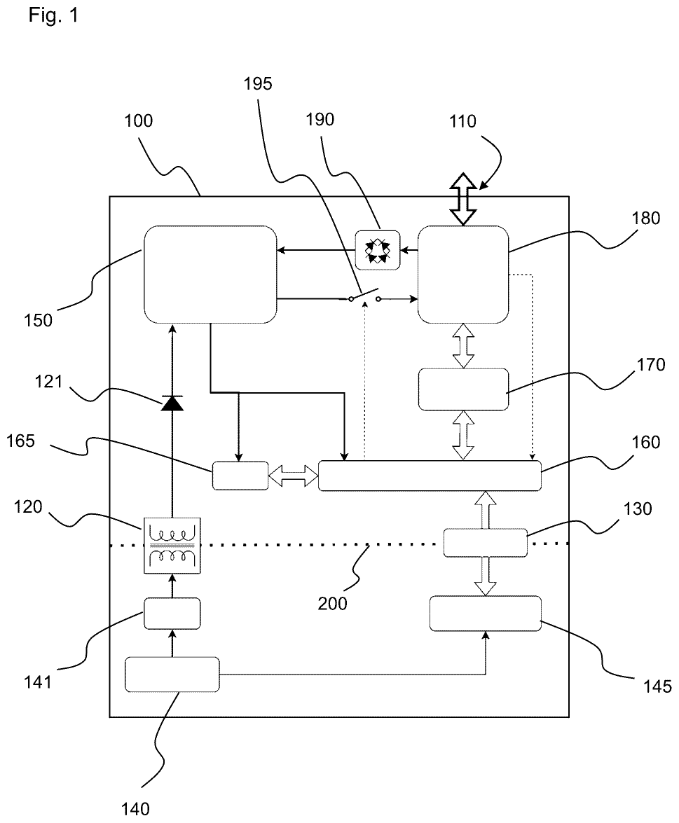

FIG. 1 shows the basic structure of a network device 100, which is used as a bus subscriber and accordingly has a bus interface 110 for connection to a bus line. In the example shown, the bus interface is designed for connection to the two lines of a two-wire bus line.

In the exemplary embodiment illustrated, the network device 100 comprises two areas that are electrically isolated from each other by an isolation barrier, which is indicated by the dashed line 200. In the exemplary embodiment illustrated, the isolation barrier comprises a transformer 120 for inductive galvanic isolation and a coupler 130, which can be designed for capacitive or optoelectronic galvanic isolation, for example, and can be designed as an optocoupler or a digital coupler, for example.

In this example, the lower area below the isolation barrier comprises the actual device functionality, whereby a power supply 140 is typically arranged there, as well as a host controller 145, which can be designed as a microcontroller, for example, and which is supplied with electrical energy via the power supply 140.

The upper area above the isolation barrier essentially comprises the components of the network device 100 involved in the bus communication. The electrical isolation of the two areas achieved by the isolation barrier advantageously serves to avoid mutual interference between the respective components. It should be noted that galvanic isolation is an advantageous design, but not one that is essential for the functioning of the network device.

In normal operation of the network device 100, the upper area of the network device 100 is supplied with electrical energy via the transformer 120, whereby the power supply 140 is connected to the transformer 120 for this purpose via a driver circuit 141.

The illustrated network device 100 further comprises an energy distribution circuit 150 that can receive, smooth, limit, switch and regulate voltage and/or current signals and can also control energy flows. For example, the DC voltage supplied via the transformer 120 and a rectifier schematically shown as diode 121 can be supplied in normal operation as a supply voltage to a control unit 160 and optionally to a storage unit 165, which is connected in communication with the control unit 160, so that these are supplied with electrical energy accordingly. The control unit 160 can, for example, be designed as a microcontroller. The control unit 160 and the storage unit 165 can also be housed in a common component. Voltage regulation and smoothing within the circuit for energy distribution 150 advantageously ensures trouble-free operation of the control unit 160.

The control unit 160 can now exchange data with the host controller 145 on the one hand via the optional isolation barrier, i.e. via the coupler 130, for example using an SPI data interface. The actual data flow via the bus system is ensured by the control unit 160 via a transmitting/receiving device 170, for example, in the form of a transceiver, which is responsible for processing the data, and via a diplexing unit 180, which is explained in more detail below and which transmits and receives the data on the two bus lines.

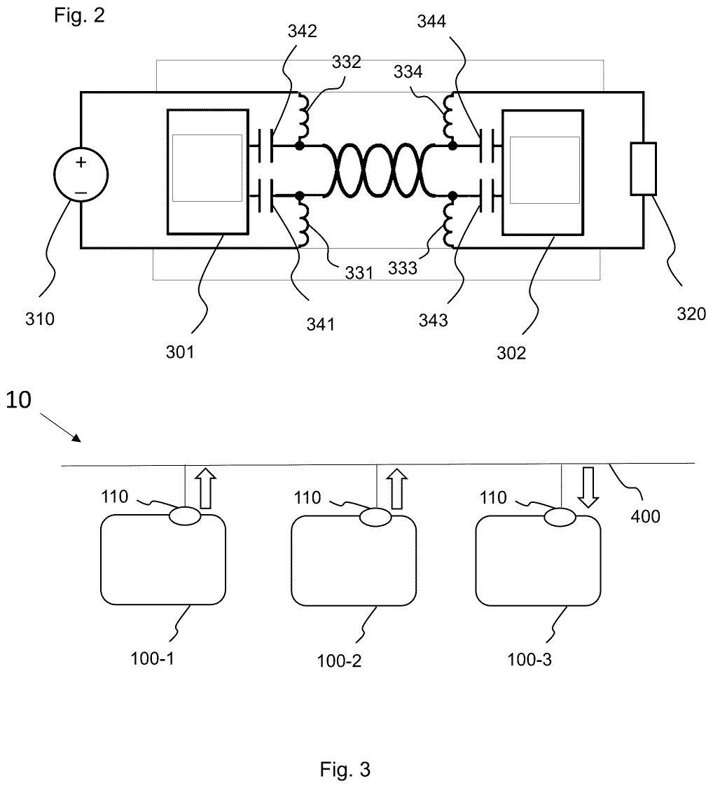

The diplexing unit 180 consists of various hardware components and has various tasks. On the one hand, the diplexing unit 180 is designed for frequency separation, whereby the principal mode of operation of the frequency separation carried out by the diplexing unit 180 is shown below in connection with FIG. 2.

FIG. 2 shows an example of how the simultaneous transmission of data and energy is solved with SPE (Single Pair Ethernet), using the PoDL (Power over Data Line) method. In the example shown, electrical energy is transmitted via a DC voltage source 310 of the subscriber 301 to the sink 320 of the subscriber 302. Since the data is also transmitted at high frequencies via the two lines, the separation is realized by means of a frequency crossover. The four inductances 331, 332, 333 and 334 shown are highly impedant for the data signal at high frequencies, i.e. they act as a barrier here, while the four capacitances 341, 342, 343 and 344 are low-impedance for the high-frequency data signal, i.e. they are permeable. For the low-frequency DC or AC energy signal, i.e., the supply voltage, the inductances are low-impedance, i.e., permeable, whereas the capacitors have a blocking effect. This means that the data signal and energy signal can be transmitted via the same 2 lines.

Referring again to FIG. 1, the energy supply can thus be separated from the data signals by means of frequency crossovers, i.e., by means of the diplexing unit 180, for example using inductances and capacitances, which is explained in more detail below.

If required, a voltage, preferably a regulated voltage, can also be switched from the energy distribution circuit via the switch 195 and the diplexing unit 180 to the bus lines via the frequency crossover. The control unit 160 has control over the switch 195, i.e., the switch 195 is designed as a controllable switch and can be controlled by the control unit 160 via a corresponding control line indicated by a dashed line. The control unit 160 preferably closes the switch 195 only if a measurement carried out by the diplexing unit 180 has shown that either no voltage or a correctly polarized voltage is present on the bus line. The result of the measurement is transmitted from the diplexing unit 180 to the control unit 160 via a suitable signal or data line. This is indicated by a dashed arrow in FIG. 1. If the measurement has shown that the bus voltage and the bus status, i.e., in particular the polarity of the voltage on the bus line, are suitable for a feed, the voltage can be switched to the bus line by closing the switch 195. It can also be advantageously provided to adapt the polarity of a voltage to be fed into the bus line depending on the voltage measured on the bus line, and in this way to realize reverse polarity protection. For this purpose, a corresponding reverse polarity protection circuit is advantageously provided, which is not shown in FIG. 1.

Advantageously, the energy distribution circuit 150 is also designed for current limiting, so that only a current with a predetermined maximum current intensity can be provided on the bus line.

In the following, the case is considered in which the actual device functionality, represented in FIG. 1 by the host controller 145 as an example, has failed and/or is not supplied with energy, but the network device 100 is connected via the bus lines. This may be the case, for example, when the device is put into operation using a special bus configuration adapter not shown. This case can also occur if the network device 100 has a defect, for example, and for this reason no electrical energy can be provided via the power supply 140.

In this case, the diplexing unit 180 can forward the voltage present on the bus to the energy distribution circuit 150, for example, using a bridge rectification circuit 190. It should be noted that the voltage present on the bus, i.e., on the bus lines, is advantageously provided by at least one other bus subscriber. The bridge rectification circuit 190 advantageously enables current to be drawn independently of the polarity of the voltage applied to the bus lines.

The energy distribution circuit 150 can now advantageously limit, regulate and/or smooth a voltage provided by the diplexing unit 180 in the manner described as required and forward the correspondingly limited, regulated and/or smoothed voltage as a supply voltage to the control unit 160 and/or the storage 165, so that the control unit can then communicate via the bus as described above, despite the lack of device voltage from the power supply 140. For example, configuration data can be read from the storage 165 even in the event of a fault or written to the storage 165 during the configuration phase.

It should be noted that, depending on the intended use, the network device 100 may comprise further components and/or assemblies that are not shown in FIG. 1.

For example, an optional internal termination can be provided.

In addition to the “diplexing” unit, further optional components may be provided, which are not shown in the figures as they are not directly relevant to the present disclosure. For example, an optional internal termination can be provided. As described above, a reverse polarity protection circuit can also be provided, which ensures that communication functions independently of the polarity of the DC voltage applied to the bus.

FIG. 3 shows an example of a system 10 with three bus subscribers 100-1, 100-2 and 100-3, whereby the bus subscribers each correspond to the network device 100 described in connection with FIG. 1. The bus subscribers are connected to a common two-wire bus line 400 via the respective bus interface 110. It is now assumed that the bus subscriber 100-3 has a defective power supply. As described above, in such a case, the disclosure advantageously enables the bus subscriber 100-3 to be supplied with electrical energy by the other bus subscribers 100-1 and 100-2. For this purpose, the bus subscribers 100-1 and 100-2 feed electrical energy into the bus line 400 as described above, while the bus subscriber 100-3 draws electrical energy from the bus line 400. This is indicated by corresponding arrows in FIG. 3. Depending on the specific configuration of the system, only one of the two bus subscribers 100-1 and 100-2 can also provide energy for the bus subscriber 100-3 or the required energy is provided in unequal parts by the bus subscribers 100-1 and 100-2.

This is an advantageous way of ensuring data communication between the three bus devices 100-1, 100-2 and 100-3, even if the internal power supply to one of the bus devices has failed.

For the sake of simplicity, FIG. 1 shows a network device 100, which comprises only one bus interface 110. However, depending on the type and topology of the bus used, a network device according to embodiments of the present disclosure can also have several bus interfaces or ports.

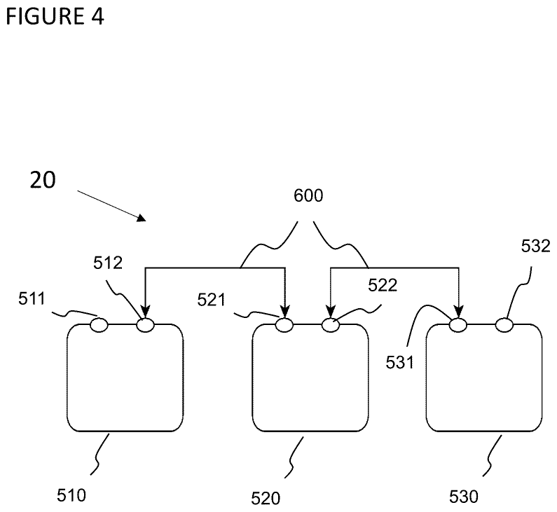

An exemplary embodiment of a system 20 according to the present disclosure with network devices having several ports is shown schematically in FIG. 4. FIG. 4 shows a highly simplified sketch of a connection of three network devices 510, 520 and 530 within a network topology. As can be seen in FIG. 4, the illustrated network 20 comprises, by way of example, a first, a second and a third network device 510, 520 and 530, each of which is electrically connected to a bus 600. The bus 600 shown can advantageously be designed as a two-wire bus and is exemplarily structured as a daisy-chain topology in FIG. 4, so that point-to-point connections are established between the individual network devices 510, 520 and 530 of the system 20 and the network devices 510, 520, 530 are arranged consecutively in a row or chain. For this purpose, each individual network device 510, 520, 530 in the embodiment example of FIG. 4 comprises two connection ports 511, 512, 521, 522, 531, 532, also called ports or physical connection points, wherein a first connection port 512 of the first network device 510 is connected to a first connection port 521 of the second network device 520 and a second connection port 522 of the second network device 520 is connected to a first connection port 531 of the third network device 530. Even if not shown in FIG. 4, further network devices to the left of the first network device 510 and/or to the right of the third network device 530 may still be connected to the network 20 in accordance with the network topology used or may be connected to the bus system 600.

In the network 20 shown in FIG. 4, the network devices can advantageously include circuit components that are designed to selectively establish or interrupt an electrical connection between the first and second bus interface of the respective network device. The network devices shown in FIG. 4 advantageously have an analog structure with regard to bidirectional energy transmission, i.e., the ability to selectively supply electrical energy to the bus or to draw electrical energy from it, as described above in connection with the network device 100 shown in FIG. 1.

As explained above, embodiments of the present disclosure advantageously enable bus devices to be used both as a source and as a sink for electrical energy, i.e. as a transmitter or receiver of energy depending on the operating mode. In this way, flexible, bidirectional energy transmission is made possible, whereby, for example, some bus subscribers can feed electrical energy onto the bus and other bus subscribers can draw electrical energy from it. Furthermore, for ease of use, it may be advantageous to provide reverse polarity protection, in particular for bus devices that act as a source of electrical energy, whereby a rectifier may be provided, in particular for bus devices that act as a sink for electrical energy, in order to provide a voltage of predetermined polarity, irrespective of the polarity of the voltage applied to the connected bus line. A further advantage of the present disclosure is that electrical energy can also be provided in the event of configuration, if a bus subscriber is connected and configured, for example, when put into operation only via the bus lines.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present disclosure requires more features.

Moreover, though the description of the present disclosure has included description of one or more embodiments, configurations, or aspects and certain variations and modifications, other variations, combinations, and modifications are within the scope of the present disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges or steps to those described in the description, whether or not such alternate, interchangeable and/or equivalent structures, functions, ranges or steps are disclosed herein, and without intending to publicly dedicate any patentable subject matter.

1. A network device, comprising
at least one bus interface for connecting the network device to a bus line, in particular a two-wire bus line, the bus interface being designed for data transmission and for energy transmission, and the network device being designed, depending on an operating mode of the network device, either to draw electrical energy from the bus line or to feed electrical energy into the bus line.

2. The network device according to claim 1, comprising
a diplexing device for frequency-selectively splitting a signal;
an energy distribution circuit; and
a transmitting/receiving device for transmitting and receiving data, wherein the bus interface is connected via the diplexing device to the energy distribution circuit and to the transmitting/receiving device.

3. The network device according to claim 1, comprising an energy supply device, wherein the network device is supplied with electrical energy by the energy supply device in a normal operating mode and is designed to feed electrical energy provided by the energy supply device into a bus line connected to the bus interface in the normal operating mode; and
wherein the network device is designed to draw electrical energy from a bus line connected to the bus interface for supplying energy to the network device in a configuration operating mode.

4. The network device according to claim 3, comprising
at least one control unit; and
a storage unit;
wherein the network device is designed to supply at least the control unit and the storage unit with electrical energy in the configuration operating mode, and to provide, via the control unit, access to the storage unit for a further network device, in particular a configuration device, which can be connected to the network device via the bus interface.

5. The network device according to claim 4, adapted to automatically switch to the configuration operation mode in case of failure of the energy supply device.

6. The network device according to one of claims 4, wherein the components of the network device involved in the data transmission and/or energy transmission via the bus interface are galvanically isolated from further components of the network device.

7. The network device according to claim 1, wherein the energy distribution circuit is configured to receive, smooth, limit, rectify, switch and/or regulate voltage and current signals.

8. The network device according to claim 1, wherein the network device comprises a measuring device for measuring a voltage applied to the bus line, and wherein the network device is designed to adjust the polarity of a voltage to be fed into the bus line as a function of the voltage measured on the bus line.

9. The network device according to claim 1, wherein the network device comprises at least a first and a second bus interface, and wherein the network device is designed to selectively establish or interrupt an electrical connection between the first and the second bus interface.

10. A System comprising
at least two network devices according to claim 1, and
a bus line, in particular a two-wire bus line;
wherein the network devices are connected to each other via the bus line.

11. The system according to claim 10, wherein at least one network device of the at least two network devices draws electrical energy from the bus line, and at least one other network device of the at least two network devices feeds electrical energy into the bus line.
